(19) United States
(12) Patent Application Publication
(10) Pub. No.: US 2016/0341629 A1
(43) Pub. Date: Nov. 24, 2016

(54) VIBRATING MACHINE

(71) Applicant: Schenck Process GmbH, Darmstadt (DE)

(72) Inventor: Jan SCHAEFER, Darmstadt (DE)

(73) Assignee: Schenck Process GmbH, Darmstadt (DE)

(21) Appl. No.: 15/226,229

(22) Filed: Aug. 2, 2016

Related U.S. Application Data
(63) Continuation of application No. PCT/EP2015/000211, filed on Feb. 3, 2015.

(30) Foreign Application Priority Data
Feb. 7, 2014 (DE) 10 2014 001 515.7

(51) Int. Cl. G01M 7/02

(52) U.S. Cl. CPC G01M 7/022; G01M 7/025

(57) ABSTRACT

A vibrating machine is provided that includes a condition-monitoring device that has a first vibrating body supported flexibly in relation to a second vibrating body or a base, a first exciter that produces a targeted vibration behavior of the vibrating machine or the vibrating body. The condition-monitoring device has at least one first micro-electro-mechanical device in the form of an inertial sensor with at least three acceleration sensors and at least three yaw-rate sensors.

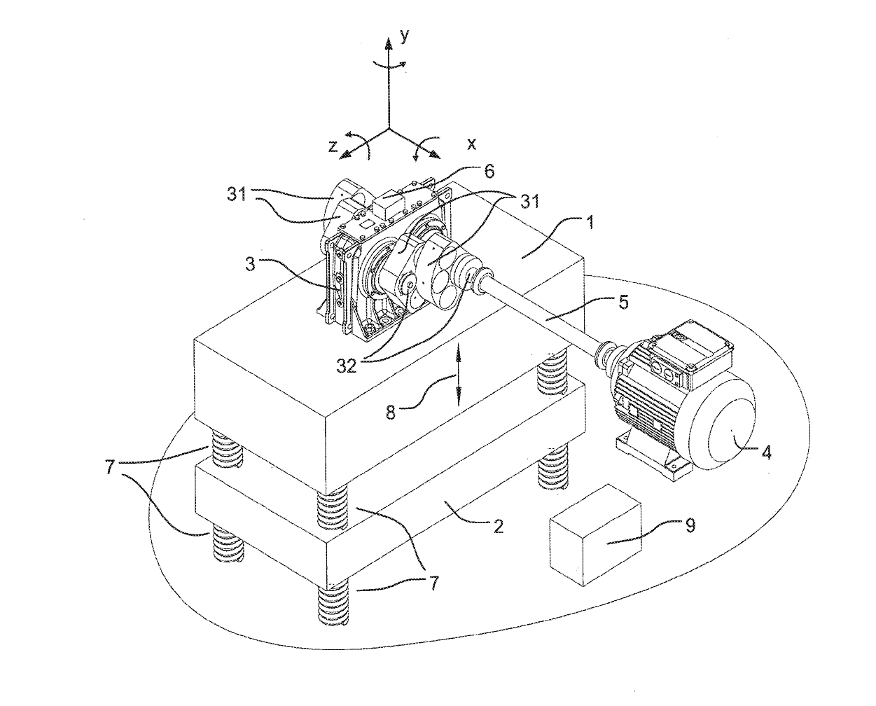

This nonprovisional application is a continuation of International Application No. PCT/EP2015/000211, which was filed on Feb. 3, 2015, and which claims priority to German Patent Application No. 10 2014 001 515.7, which was filed in Germany on Feb. 7, 2014, and which are both herein incorporated by reference.

### BACKGROUND OF THE INVENTION

Field of the Invention

The present invention relates to a vibrating machine.

Description of the Background Art

Self-induced vibrations in industrial machines with rotating parts are undesirable in general. For this reason, vibration parameters are also defined in standards and regulations, for example, in DIN ISO 10816 on the basis of which the vibration behavior of machines with rotating parts can be evaluated. Conclusions about the current condition of a machine can be reached with use of these vibration parameters and prognoses about the remaining operational life can be made.

In contrast, vibrating machines such as vibrating screens, vibrating conveyors, or vibrating centrifuges experience a continuous vibration load that is necessary for fulfilling their function. They typically have an exciter with one or more unbalanced masses or a magnetic exciter, which incites the vibrating machine to perform a vibrating movement. This vibrating movement is used specifically in conveying processes for screening and separating processes or also for comminution processes with subsequent or simultaneous material transport. Such vibrating machines are used accordingly often or predominantly in the processing and transport of bulk materials of different sizes and composition. Because of the constant vibration load they are subject to excessive wear. Progressive wear can have the result that the vibrating machine has a vibration behavior different from the one desired. On the one hand, this can adversely affect the desired function fulfillment of the vibrating machine and, on the other, it can accelerate the wear process, which leads to total failure of the vibrating machine. To avoid rather longer downtimes caused by component defects, it is worthwhile to be able to deduce the operational life of a component before its total failure. It is therefore known from the prior art to equip vibrating machines of any type with devices for monitoring the operational state.

Various approaches for monitoring the condition of a vibrating machine are currently known, which can be used individually or in addition for detecting the condition of the vibrating machine.

A first approach is the monitoring of the bearings and/or drives, which are typically built into the exciter and enable the desired force transmission. These bearings and/or drives are typically monitored by determination of the structure-borne sound, which is typically measured by means of piezoelectric acceleration sensors. An example of this approach is EP 1285175 A1, which corresponds to U.S. Pat. No. 6,877,682, in which the bearings are monitored by different sensors, a mechanical and a piezoelectric sensor. The measured acceleration frequencies of interest in this approach are typically in the range of a few 100 Hz to several 1000 Hz and comprise structural resonance frequencies of the exciters, which are caused to vibrate by bearing and/or drive damage.

A second approach to monitoring the condition of vibrating machines is performing modal analyses to detect the structural dynamics. Information about the structural dynamics in the case of vibrating machines is important, first of all, to make sure that the operating frequency is outside the existing natural frequencies of the vibrating machine. Furthermore, conclusions can be reached about changes in the condition by repeated modal analyses and result comparisons. As a result, the conditions of all components can be monitored that have an effect on the structural dynamics of the vibrating machine. DE 102008019578 A1, which corresponds to US 20110016974, describes an implementation for monitoring the structural dynamics to be able to draw inferences about the machine condition. Here, amplitude or resonance spectra are recorded repeatedly by means of an acceleration sensor, and these are compared with a previously known amplitude spectrum. The difference between the current and previously known spectrum is used as an indicator of possible damage. Modal analyses are always carried out in a machine that is not running.

A third approach to monitoring the condition of vibrating machines is the direct measurement-based recording of the vibration behavior during operation. The vibration behavior of vibrating machines is typically also recorded with use of piezoelectric acceleration sensors. As opposed to the aforesaid approach to bearing and/or drive monitoring, the frequencies of interest in this approach correspond to the excitation frequency itself and optionally to multiples of the excitation frequency. The exciter frequency of vibrating machines is typically in the range of a few Hz to <30 Hz. A plurality of piezoelectric acceleration sensors are typically mounted on the vibrating machine such that a multidimensional monitoring of the vibration behavior is enabled. If the vibrating machine is regarded in simplified terms as a rigid body, the physical principle applies that this body has six degrees of freedom, three translational and three rotational. The use of piezoelectric acceleration sensors therefore permits the direct recording of three of the six possible degrees of freedom, namely, the translational ones. The missing rotational movement patterns can be derived theoretically indirectly from the relative evaluation of spatially separate but similarly oriented acceleration sensors. This method for recording rotational movements is always afflicted with inaccuracies, however.

### SUMMARY OF THE INVENTION

It is therefore an object to determine deviations in vibration behavior in vibrating machines in order to be able to make inferences about the operational state.

It has turned out against this background that apart from determining temperature increases in lubricating fluids or lubricating oil of bearing parts and determining an increasing vibration load in the form of structure-borne sound, a vibration behavior deviating from the normal vibration behavior can indicate the approaching failure of specific components of the vibrating machine. Furthermore, a vibration behavior deviating from the desired vibration behavior indicates a limited function fulfillment of the vibrating machine.

In an exemplary embodiment, the invention provides a vibrating machine with a condition-monitoring device, which comprises a first vibrating body supported elastically or flexibly in relation to a second vibrating body or a base. The first vibrating body can be a vibrating housing or a vibrating frame, which contains further components or parts such as a screen surface or reinforcements. This first vibrating body is generally supported by means of steel springs elastically in relation to the second vibrating body or the base. Optionally, however, elastomeric bearings or other elastic bearings may also be used. The second vibrating body, which serves as a vibration absorber, can be an insulating frame in this case, which in turn is supported elastically in relation to the base. Furthermore, the vibrating machine comprises at least one first exciter that produces a targeted vibration behavior of the vibrating machine or vibrating body. The vibrating machine generally also has a motor for driving the exciter and a universal drive shaft for connecting the motor to the exciter. The exciters can be directional exciters, which cause the vibrating machine to vibrate with a targeted translational direction, or circular exciters, which drive the vibrating machine to perform a circular vibrating movement.

According to an embodiment of the invention, the vibrating machine in addition comprises a condition-monitoring device.

The condition-monitoring device in turn can comprise a device for monitoring the vibration behavior and/or a device for structure-borne sound measurement and/or a temperature-measuring device. The device for monitoring the vibration behavior as part of the condition-monitoring device has at least one first microelectromechanical device in the form of an inertial sensor, said device being equipped with at least three acceleration sensors and at least three yaw-rate sensors. Whereas piezoelectric acceleration sensors have a continuous mechanical coupling between the measurement object and the piezoelectric element and thereby are especially highly suitable for picking up structure-borne sound in the high-frequency range of several kHz, inertial sensors, therefore inertia-based yaw-rate and acceleration sensors, are especially highly suitable for motion recording in the low-frequency range of 0 to a few hundred Hz. Inertial sensors typically are microelectromechanical systems (MEMS) and are usually made from silicon. These sensors are spring-mass systems in which the springs are silicon rods only a few micrometers wide and the mass is also made of silicon. A change in the electrical capacitance between the sprung-suspended part and a fixed reference electrode can be measured by the displacement during acceleration.

Whereas the acceleration sensors, which are each disposed orthogonally to one another in the inertial sensor, measure the linear accelerations in the x- or y- or z-axis, from which the distance covered by the vibrating machine can be calculated by double integration, the yaw-rate sensors measure the angular velocity about the x- or y- or z-axis, so that the angular change can be determined by simple integration. An inertial sensor with three acceleration sensors and three yaw-rate sensors is also called a 6D MEMS sensor. Magnetometers can be used in addition to determine the absolute position of the sensor in space, whereby the arrangement of three magnetometers for detecting of three axes again arranged orthogonal to one another is advantageous. The term 9D MEMS sensor is used correspondingly in the case of a combination of three acceleration sensors, three yaw-rate sensors, and three magnetometers. The inertial sensor can be augmented furthermore by a pressure sensor and/or a temperature sensor.

Thus, a six-dimensional inertial sensor, which contains three translational and three rotational measuring axes, is ideal for detecting the vibration behavior of vibrating machines and can completely detect the movement of the vibrating machine, regarded as a rigid body, in space.

Requirements for the vibration behavior relate, e.g., to the vibration frequency, vibration amplitudes, and the vibration mode.

If the position and orientation of the six-dimensional inertial sensor are known, all movements in the form of acceleration, velocity, and path for each point of the rigid body can be calculated by adapted conversion algorithms.

Damage to springs or bearings and damage to the universal drive shafts and universal intermediate shafts can be detected in this way with the device for monitoring the vibration behavior. Furthermore, cracks or breaks on side cheeks, crossmembers, and longitudinal sliders can be determined. Lastly, faulty loads in the form of a too high or asymmetric load or faulty screen cloth components can also be determined.

Damage to bearings and gears, for example, ruptures on the bearing surfaces of bearings, emit structure-borne sound in the form of shock pulses. These signals can be measured by a device for structure-borne sound measurement in the form of one or more piezoelectric acceleration sensors. The piezoelectric acceleration sensors can be provided on the vibrating machine at a place different from the inertial sensors. The measured data of piezoelectric acceleration sensors can be converted, for example, to the state variables: effective value, crest factor, and/or kurtosis. Other state variables are possible.

Advantageously, the inertial sensor for monitoring vibration behavior of the vibrating machine can be augmented by a data memory and/or processor. Accordingly, the inertial sensor(s) and/or the data memory and/or the processor are disposed on a circuit board. An assembly, comprising at least one inertial sensor and a processor, is used as the device for measured data acquisition. The device for measured data acquisition can contain in addition a device for structure-borne sound measurement, a temperature measuring device, a memory, and/or a module for transmitting digital data. The required measured data can be determined with said device and forwarded to an evaluation device.

According to an embodiment of the invention, the device for measured data acquisition as part of the condition-monitoring device of a vibrating machine and thereby a first inertial sensor can be disposed directly on the exciter of the vibrating machine. In this case, it can be attached to, in, or on the exciter housing. Vibrating machines, preferably vibrating screens, often have at least one second exciter. Particularly in vibrating screens with large masses, this second exciter together with the first exciter generates the necessary vibrating movement of the vibrating body. In order to generate an equally acting movement, it is necessary to couple these exciters to one another. This typically occurs by a connection via a universal intermediate shaft. Because this type of universal intermediate shaft is also subject to high wear due to the vibration stress, the invention provides a second inertial sensor for monitoring the universal intermediate shaft. The second inertial sensor is advantageously also attached directly to the second exciter. The phase difference of the shock accelerations between the first and second exciter, obtained from the respective measurement axes of the two inertial sensors, can be used as parameters for the condition of the universal intermediate shaft.

An evaluation of the vibration behavior of the vibrating machine, e.g., via the state variables: acceleration amplitude, yaw-rate amplitude, vector change of the shock indicator, phase shift, and/or THD or harmonic distortion can be possible according to the invention with the aid of the first and/or of the second inertial sensor. Further analysis algorithms are possible. To this end, the condition-monitoring device comprises an electronic evaluation device. The electronic evaluation device is provided for receiving measured data of the device for measured data acquisition and for evaluating the measured data in regard to the aforesaid state variables. A comparative examination of the calculated state variables and the defined limit values can then occur with the aid of the electronic evaluation device. Depending on the task, an evaluation can occur in a way that the state variables are compared with a defined limit value, which was stored as an absolute value in the evaluation device, or that an initial value with a tolerance range is provided as a defined limit value.

Advantageously, the electronic evaluation device comprises a display for showing the state variables and/or a warning display or a warning signal generator when defined limit values are exceeded. The user can be signaled thereby whether the vibrating machine moves within the predetermined limit values or whether these are being exceeded. In order to avoid false alarms resulting from fleeting/transient signals, the condition-monitoring algorithms can be expanded such that alarm states are triggered only upon a repeated or longer occurrence.

An embodiment of the vibrating machine with a condition-monitoring device provides that the device comprises two modules disposed separated from one another. In this case, the device for measured data acquisition as the first module can be attached directly to the vibrating machine or the exciter and the evaluation device as the second module can be disposed spatially separated from the first module or also spatially separated from the vibrating machine. In the separate arrangement of the device for measured data acquisition and the evaluation device, the communication cable is again a component that because of the constant vibration load by the screening machine is subject to increased wear. To avoid system failures caused by cable breaks, the invention accordingly provides a wireless connection between the evaluation device and the device for measured data acquisition.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURE

The present invention will become more fully understood from the detailed description given hereinbelow and the accompanying drawing which is given by way of illustration only, and thus, is not limitive of the present invention, and wherein the sole FIGURE illustrates a vibrating machine in schematic spatial illustration.

### DETAILED DESCRIPTION

The FIGURE shows a vibrating machine having a first vibrating body 1 and a second vibrating body 2, each of which is supported flexibly. In this case, vibrating body 1, which can be, for example, a frame of a vibrating screen including a screening surface, is supported by springs 7 in relation to vibrating body 2. Vibrating body 2, which can be, for example, an insulation frame, is also supported flexibly in relation to the solid base or ground. Vibrating body 2 in such a case can be described as a vibration absorber or vibration damper. The task of such a vibration absorber or vibration damper is to eliminate vibrations that could lead to damage in the base or in the structure connected to the base. Both vibrating bodies 1 and 2 in the present exemplary embodiment are caused to execute a linear vibration motion by an exciter 3, whereby this vibration movement occurs in a predetermined direction indicated by double arrow 8, the impact direction of the exciter. Exciter 3, a so-called directional exciter, is attached centrally to first vibrating body 1 and has unbalanced masses 31, whose centers of gravity are arranged eccentrically to rotation axis 32.

Exciter 3 in turn is driven by a motor 4, which is connected via a drive shaft 5 to exciter 3.

Even if the vibrating machine vibration movement produced by exciter 3 is given only in one direction, the vibrating machine due to its six degrees of freedom executes linear movements in three independent directions x, y, and z and rotational movements about the axes x, y, and z. For a complete motion detection of vibrating body 1 in space, in this exemplary embodiment a device for measured data acquisition 6 as part of a condition-monitoring device of the vibrating machine is attached to the housing cover of exciter 3. Alternatively, it can also be disposed at any other place of the vibrating machine. This device for measured data acquisition 6 includes at least one inertial sensor and a processor. The inertial sensor is a 6D MEMS sensor, which comprises three acceleration sensors and three yaw-rate sensors. Alternatively, an inertial sensor in the form of a 9D MEMS sensor could be used, which comprises 3 magnetometers in addition to the three acceleration and yaw-rate sensors.

The measured data recorded by the device for measured data acquisition 6 by means of inertial sensor in the present embodiment are sent wirelessly to an evaluation device 9, where the transmitted data for condition monitoring of the vibrating machine in the form of state variables such as acceleration amplitude, yaw-rate amplitude, vector change of the impact indicator, phase shift, and/or THD or harmonic distortion are processed further. Evaluation device 9 comprises apart from a data memory a computing unit for processing the measured data recorded by the inertial sensor, as well as a display unit in the form of a screen. For condition monitoring, the display unit can be used both as a warning signal generator and for displaying the current state of the vibrating machine. Furthermore, evaluation device 9 comprises serial communication interfaces and switch outputs, which are switched in the alarm state.

The evaluation of the current state in the form of current state variables in comparison with predetermined limit values permits the user to make a prognosis on the life expectancy of the monitored parts, components, or vibrating machine overall. Furthermore, the state variables within the given limit values determine a requested function fulfillment for the vibrating machine.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vibrating machine with a condition-monitoring device, the vibrating machine comprising:
a first vibrating body supported elastically with respect to a second vibrating body or a base;
a first exciter that produces a targeted vibration behavior of the vibrating machine or vibrating body; and
at least one first microelectromechanical device provided in the condition-monitoring device, the at least one first microelectromechanical device being an inertial sensor having at least three acceleration sensors and at least three yaw-rate sensors.

2. The vibrating machine according to claim 1, wherein the inertial sensor comprising a data memory and/or processor.

3. The vibrating machine according to claim 1, further comprising at least one second exciter that is connected via a universal intermediate shaft to the first exciter.

4. The vibrating machine according to claim 1, wherein the inertial sensor is provided at, in, or on a housing of at least one exciter.

5. The vibrating machine according to claim 1, wherein the condition-monitoring device evaluates a vibration behavior of the vibrating machine in relation to state variables that include: acceleration amplitude, yaw-rate amplitude, vector change of the impact indicator, phase shift, and/or THD or harmonic distortion individually or in combination with one another.

6. The vibrating machine according to claim 1, further comprising an electronic evaluation device for receiving measured data of the inertial sensor or the inertial sensors and for evaluating the measured data in relation to state variables including: acceleration amplitude, yaw-rate amplitude, vector change of the impact indicator, phase shift, and/or THD or harmonic distortion individually or in combination with one another.

7. The vibrating machine according to claim 6, wherein the electronic evaluation device is provided for a comparative examination of the determined state variables and defined limit values.

8. The vibrating machine according to claim 7, wherein an absolute value is provided as the defined limit value.

9. The vibrating machine according to claim 7, wherein an initial value with a tolerance range is provided as the defined limit value.

10. The vibrating machine according to claim 1, wherein the electronic evaluation device comprises a display for showing state variables and/or a warning display or a warning signal generator when defined limit values are exceeded.

11. The vibrating machine according to claim 1, wherein the electronic evaluation device of the condition-monitoring device of the vibrating machine and a device for measured data acquisition are provided spatially separated from one another.

12. The vibrating machine according to claim 1, wherein the connection between the electronic evaluation device and the device for measured data acquisition is provided wirelessly.
